(19) United States
(12) Patent Application Publication
(10) Pub. No.: US 2013/0283574 A1
(43) Pub. Date: Oct. 31, 2013

(54) SAFETY LOCK FOR PORTABLE COMPUTERS

(71) Applicant: ZONG-LIN SIE, New Taipei City (TW)

(72) Inventor: ZONG-LIN SIE, New Taipei City (TW)

(21) Appl. No.: 13/459,261

(22) Filed: Apr. 30, 2012

(51) Int. Cl. G06F 1/16

(52) U.S. Cl. CPC G06F 1/1679
USPC 24/303

(57) ABSTRACT

A safety lock for portable computers includes a first magnetic body and a control unit that are respectively mounted to a first portion and a second portion of a portable computer that respectively carry a display screen and a keyboard. The control unit forms an accommodation chamber and receives therein a second magnetic body. The accommodation chamber has an opening. The second magnetic body is controlled by a force application member for selective movement. Normally, the two magnetic bodies are separated by a distance to induce a magnetic attraction. When the force application member is operated to move the second magnetic body to correspond in position to the first magnetic body, an opposite-polarity repulsion is induced, which generates an upward driving force on the first portion thereby resulting in a released condition, allowing a user to lift up the display screen for use in an effortless, easy, and quick manner.

### (a) TECHNICAL FIELD OF THE INVENTION

The present invention generally relates to a safety lock for portable computers that is simple in structure and easy to use, and more particularly to a lock that can easily control safe opening of portable computers.

### (b) DESCRIPTION OF THE PRIOR ART

Portable computers are advantageous in being easy to carry and allowing for use at any time. These make the portable computers a handy tool for business persons and even students. The portable computers are constructed by separating a host device and a keyboard and a display screen in two individual portions that are connected to each other through a hinge device. Although the hinge device provides a resistance against opening, yet for safety purposes, the two portions of the portable computers are often locked together by a simply-structured lock, which is releasable by manual operation of a knob, in order to allow a user to open up the display screen for use.

Such a known lock is easy to operate, but the knob is biased by a spring, so that when the knob is manually moved to a released condition, it must be stably held by the user's against the biasing force of the spring that intends to return the knob back to the locked condition, and at the same time, the user must be use his or her to lift up the display screen. This is certainly troublesome for the users. In addition, the lock is expensive and required an additional and complicated process for installation. All these make it necessary for further improving the computer lock.

### SUMMARY OF THE INVENTION

The primary purpose of the present invention is to provide a safety magnetic lock for portable computers that is of a simple structure and is easy to operate.

The present invention provides a safety lock for portable computers, which is arranged at corresponding locations of a display screen portion and a host device and keyboard portion of a portable computer and comprises a first magnetic body and a control unit. The control unit comprises an accommodation chamber in which a second magnetic body is received. The control unit forms an opening at a location corresponding to the first magnetic body. The opening has an end wall forming a cutoff through which a force application member is allowed to connect to the second magnetic body. As such, through magnetic attraction or repulsion, a safety condition of the portable computers can be easily released by manual operation of the force application member to change the relative position between the second magnetic body and the first magnetic body, in order to allow a display screen to be lifted up for use.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view showing a safety lock for portable computers according to a first embodiment of the present invention.

FIG. 2 is a cross-sectional view illustrating magnetic bodies and a control unit of the safety lock of the first embodiment of the present invention located in a safety condition.

FIG. 3 is a cross-sectional view taken along line A-A of FIG. 2.

FIG. 4 is a schematic view illustrating a safety-released condition of the safety lock of the first embodiment of the present invention.

FIG. 5 is a perspective view showing a safety lock for portable computers according to a second embodiment of the present invention.

FIG. 6 is a cross-sectional view illustrating magnetic bodies and a control unit of the safety lock of the second embodiment of the present invention located in a safety condition.

FIG. 7 is a front view of a control unit of the safety lock of the second embodiment of the present invention.

FIG. 8 is a schematic view illustrating a safety-released condition of the safety lock of the second embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

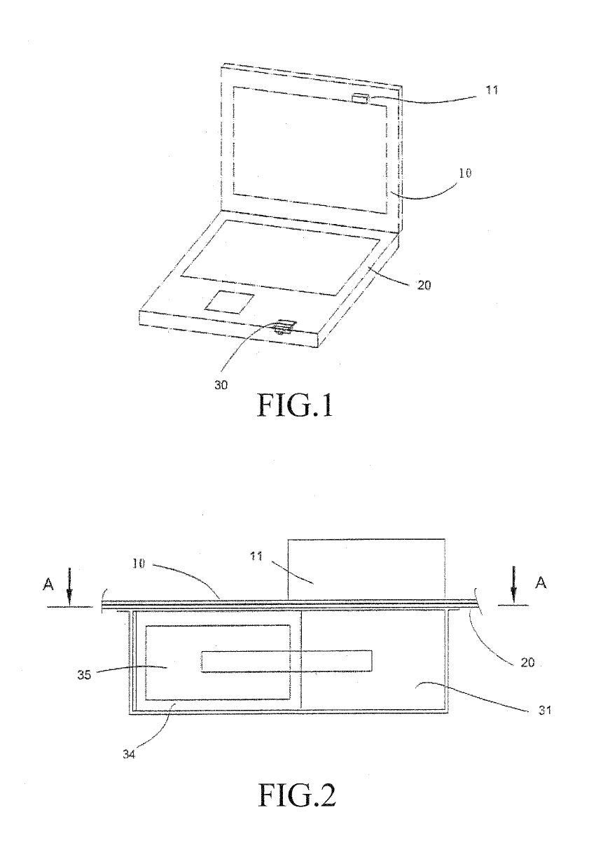

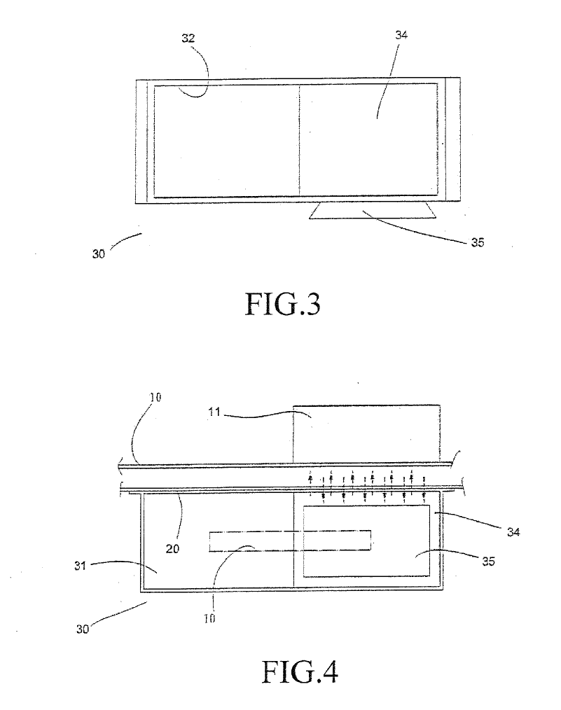

As shown in FIG. 1, the present invention provides a safety lock for portable computers, which is arranged at corresponding locations on a first portion 11 and a second portion 20 of a portable computer that respectively carry a display screen and a host device and a keyboard by respectively ins ailing a magnetic body 11 and a control unit 30 at such locations. The control unit 30 forms an accommodation chamber 31. Reference is now made to FIG. 2, which illustrates spatial relationship between magnetic bodies when the portable computer is closed. The accommodation chamber 31 receives therein a second magnetic body 34. The control unit 30 forms an opening 32 (see FIG. 3) at a location corresponding to the first magnetic body 11. The opening 32 has an end wall that forms a cutoff 33. The cutoff 33 allows a force application member 35 to couple to the second magnetic body 34 with leftward and rightward movability. The accommodation chamber 31 provides a space that is sufficient for leftward and rightward movement of the second magnetic body 34.

When the first and second magnetic bodies 11, 34 are off position with respect to each other and thus out of phase, a physical phenomenon of opposite-polarity attraction is induced, which results in a safety-locked condition, whereby the first portion 10 and the second portion 20 are secured to each other by the attraction. As shown in FIG. 4, when it is attempted to use the portable computer, the force application members 35 is manually shifted to cause the second magnetic body 34 to be in position and thus in phase with respect to the first magnetic body 11, which results in identical-polarity repulsion between the magnetic bodies 11, 34, thereby releasing the safety-locked condition and providing the first portion 10 with an upward driving force. As such, a user may easily lift up the display screen and there is no longer needed, as conventionally required, for the user to simultaneously perform a releasing operation and lift up the screen.

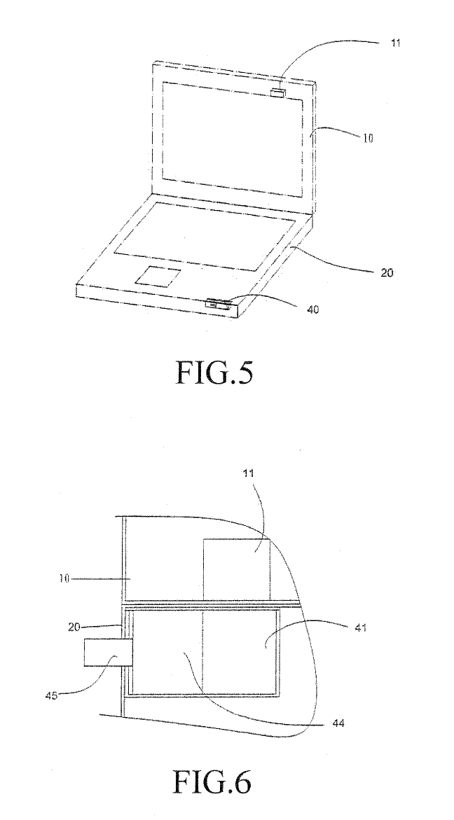

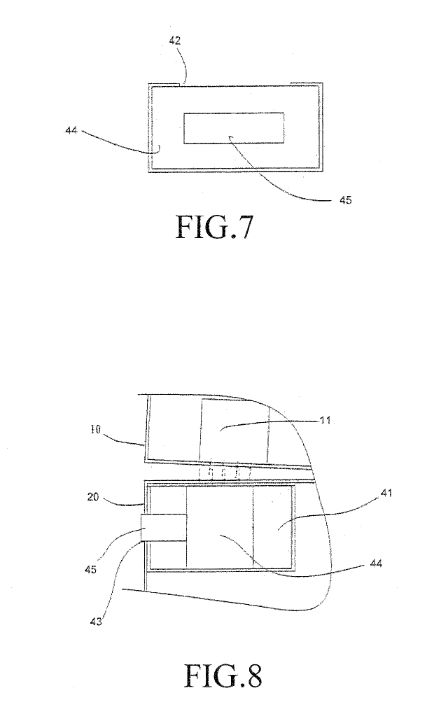

In another embodiment of the safety lock for portable computers according to the present invention, as shown in FIGS. 5 and 6, a magnetic body 11 and a control unit 40 are respectively mounted to corresponding locations on a first portion 11 and a second portion 20 of a portable computer that respectively carry a display screen and a host device and keyboard. The control unit 40 forms an accommodation chamber 41. Reference is now made to FIG. 6, which illustrates spatial relationship between magnetic bodies when the portable computer is closed. The accommodation chamber 41 receives therein a second magnetic body 44. The control unit 40 forms an opening 45 (see FIG. 7) at a location corresponding to the first magnetic body 11. The opening 45 has an end wall, which constitutes a side wall of the second portion 20, and the end wall forms a cutoff 43. The cutoff 43 allows a force application member 45 to couple to the second magnetic body 44 for operation. A difference of the instant embodiment from the previous embodiment is that the cutoff 43 does not allow for leftward and/or rightward movement of the force application member 45, and the accommodation chamber 41 provides a space that is sufficient for inward retraction of the second magnetic body 44.

As shown in FIG. 6, when the first and second magnetic bodies 11,44 are off position and thus out of phase with respect to each other, a physical phenomenon of opposite-polarity attraction is induced, which results in a safety-locked condition, whereby the first portion 10 and the second portion 20 are secured to each other by the attraction. As shown in FIG. 8, when it is attempted to use the portable computer, the force application members 45 is depressed to cause the second magnetic body 44 to retract inward and get close to be in position and thus in phase with respect to the first magnetic body 11, identical-polarity repulsion results to release the safety-locked condition and a user is allowed to easily lift up the display screen.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A safety lock for portable computers, which comprises a first magnetic body and a control unit respectively mounted at corresponding locations on a first portion and a second portion of the portable computer that respectively carry a display screen and a host device and a keyboard, the control unit forming an accommodation chamber, which receives therein a second magnetic body, the control unit forming an opening at a location corresponding to the first magnetic body, the opening having an end wall forming a cutoff through which a force application member is connected to the second magnetic body, whereby by using the force application member to change position of the second magnetic body with respect to the first magnetic body, magnetic attraction and magnetic repulsion is selectively induced to secure and release a safety condition.

2. The safety lock for portable computers according to claim 1, wherein the accommodation chamber forms a space that is sufficient for movement of the second magnetic body as being operated by the force application member.
